(19) United States
(12) Patent Application Publication
(10) Pub. No.: US 2012/0229537 A1
(43) Pub. Date: Sep. 13, 2012

(54) Defective Jet Detection Mechanism

(76) Inventors: Larry Ernst, Longmont, CO (US); George Promis, Westminster, CO (US)

(21) Appl. No.: 13/042,857

(22) Filed: Mar. 8, 2011

(51) Int. Cl. B41J 29/38

(52) U.S. Cl. 347/9

(57) ABSTRACT

A method is disclosed. The method includes analyzing an image of a flush line pattern applied to a print medium to extract print quality information for an ink jet print head.

### FIELD OF THE INVENTION

The invention relates to the field of printing systems. Particularly, the invention relates to maintaining ink jet printing systems.

### BACKGROUND

An ink jet printer is as an example of a printing apparatus that ejects droplets of ink onto a recording medium such as a sheet of paper for printing an image on the recording medium. Ink jet printers include one or more print engines having at least one ink jet print head provided with an ink cartridge that accommodates the ink. In operation of the print engine, ink is supplied from the ink cartridge to ejection nozzles in each print head so that a printing operation is performed by ejection of the ink droplets from selected ejection nozzles.

Periodically during printing an ink jet print head is required to be flushed to ensure that the individual jet nozzles stay wet in order to prevent defective jet conditions attributed to ink drying at unused nozzles. One technique commonly implemented flush method is referred to as “line flushing.” In line flushing all primary colors are printed on top of each other at the top of each printed page. Since the resulting flush line has no desired use in the final print product it is removed from each page by post processing equipment.

However, it would be desirable to use the flush line to obtain defective jet detection information from the printer.

### SUMMARY

In one embodiment, a method is disclosed. The method includes analyzing an image of a flush line pattern applied to a print medium to extract print quality information for an ink jet print head.

In a further embodiment a printing system is disclosed. The printing system includes one or more print engines each having a plurality of ink jet nozzles to print a flush line pattern on a medium, a reader to capture an image of the flush line pattern and a controller to analyze the image of the flush line pattern to extract print quality information.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIGS. 2A and 2B illustrate embodiments of flush line patterns; and

FIG. 3 is a flow diagram for one embodiment of performing defective jet detection.

### DETAILED DESCRIPTION

A defective jet detection mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

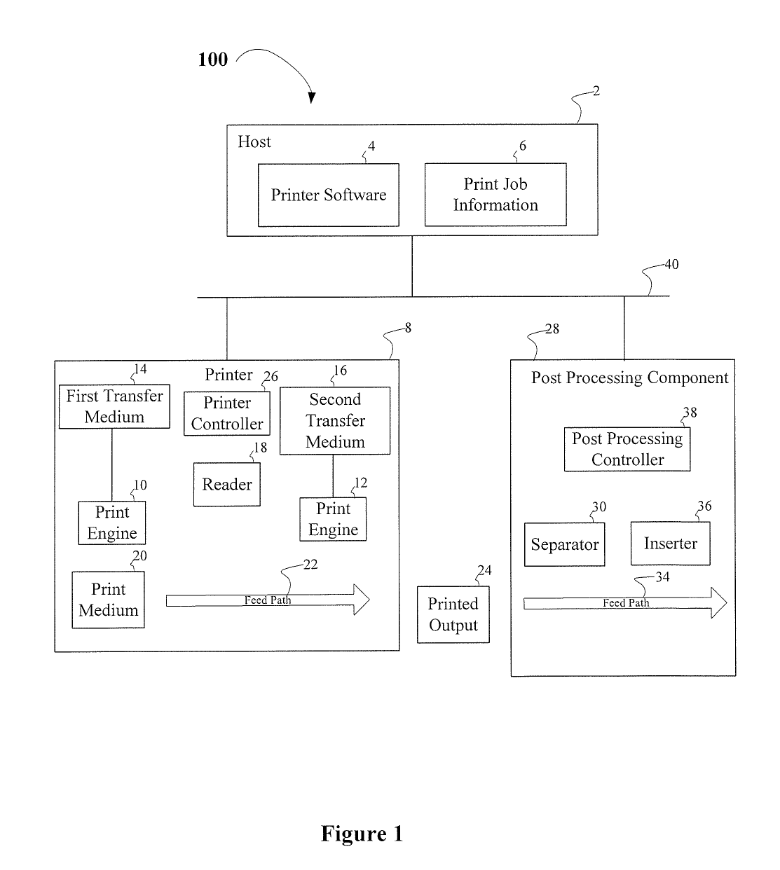

FIG. 1 illustrates one embodiment of a printing system 100. Printing system 100 includes a host system 2 having printer software 4 to manage print jobs and to maintain print job information 6 on the status of print jobs managed by printer software 4. In one embodiment, printer software 4 may be implemented using either InfoPrint Manager (IPM) or InfoPrint ProcessDirector (IPPD), although other types of printing software may be used instead.

The term print job as used herein refers a print job or any component thereof, including a page of print content, a page including multiple print items or elements, such as checks, pages, an element on a page, etc. The print job may further include one or more pages, where each page has one or more elements, e.g., checks. A page may include a unit of print output, where the page may be outputted on a single piece of a print medium or multiple pages may be outputted on a roll, ribbon or web of a print medium.

Pages may be outputted on a web of a print medium in different formats, such as 2-up duplex. Each of the pages on a web or roll of paper may include multiple elements. The web may include print jobs, where each print job is one or more pages, and where each page includes one or more elements. In this way, elements and pages may be grouped in print jobs.

Host system 2 may include a processor (not shown) and memory (not shown) in which printer software 4 and print job information 6 is stored for access by the processor. The host system 2 communicates print jobs to printer 8, where each print job may have one or more pages or elements, and where each page may have one or more elements. The printer 8 includes first 10 and second 12 print engines to print output using first 14 and second 16 types of transfer media and a reader 18 capable of reading content printed using the first transfer medium 14.

Transfer media 14 and 16 includes the material or energy that is used to cause the formation of content on print medium 20. In one embodiment, transfer media 14 and 16 include wide-array inkjet print heads that employ multiple sets of nozzles that are implemented to spray droplets of ink in order to execute a print job. A print medium 20, such as a piece of paper or other material or textile, is directed through a feed path 22 by mechanical components of the printer 8, such as rollers, guides, etc. In the feed path 22, the first print engine 10 prints first content of the one or more pages of one or more print jobs on the print medium 20 using the first transfer medium 14. The first content that is printed may include an element, a page, a page of elements, etc.

A reader 18 provides print verification by reading the printed first print content to determine the quality of the output. The reader 18 may read each element on one or more pages to determine the quality of each outputted element. The reader 18 forwards the print medium 20 to the second print engine 12 to print second content using the second transfer medium 16 to produce printed output 24 including one or more print jobs of one or more pages having one or more elements printed using both transfer media 14 and 16.

The printer 8 may include a printer controller 26 to control printing operations and interface with the printer software 4 to execute the commands from the printer software 4 and provide feedback thereto. The print engines 10 and 12 may include the hardware and/or software to control the printing of content using the first 14 and second 16 types of transfer media, respectively.

The printed output 24 is forwarded to a post processing component 28 which performs various post processing operations on the printed output 24. In one embodiment, post processing includes a separator 30 that separates the paper web into separated print job output. Additional post processing may also be performed on the separated output pieces, including include stapling, collating, printing, labeling, etc.

The post processing component 28 subsequently outputs the separated output in a final form, which may include envelopes having the separated output pieces. The post processing component 28 may include a post processing controller 38 to control post processing operations and interface with the printer controller 26 and printer software 4 to execute the commands from the printer software 4 and provide feedback thereto.

An interface 40 provides intercommunication among the host 2, the printer 8, and the post processing component 20. The interface 40 may include a network, such as a Local Area Network (LAN), a Wide Area Network (WAN), a wireless network, etc. Alternatively, the interface 40 may include a bus interface, parallel interface, serial interface, or other direct line connection. In the embodiment of described herein, the host 2, printer 8, and post processing component 20 are shown as included in separate boxes. In an alternative implementation, the printer 8 and post processing component 20 may be included in a single machine connected via one connection to the host 2. Alternatively, all three devices 2, 8, and 20 may be included in one machine.

As discussed above, line flushing is performed at ink jet print heads to ensure that the individual jet nozzles remain sufficiently wet to maintain print quality. According to one embodiment, printing system 100 uses the flush line pattern to extract print quality information. In such an embodiment, a unique pattern is included at the same location as the flush line pattern (e.g., at the top of each page of a print job). Reader 18 is subsequently implemented to capture the printed pattern as a bitmap, which is analyzed by printer controller 26 to detect a defective jet. The results may be recorded along with the degree of severity for additional analysis.

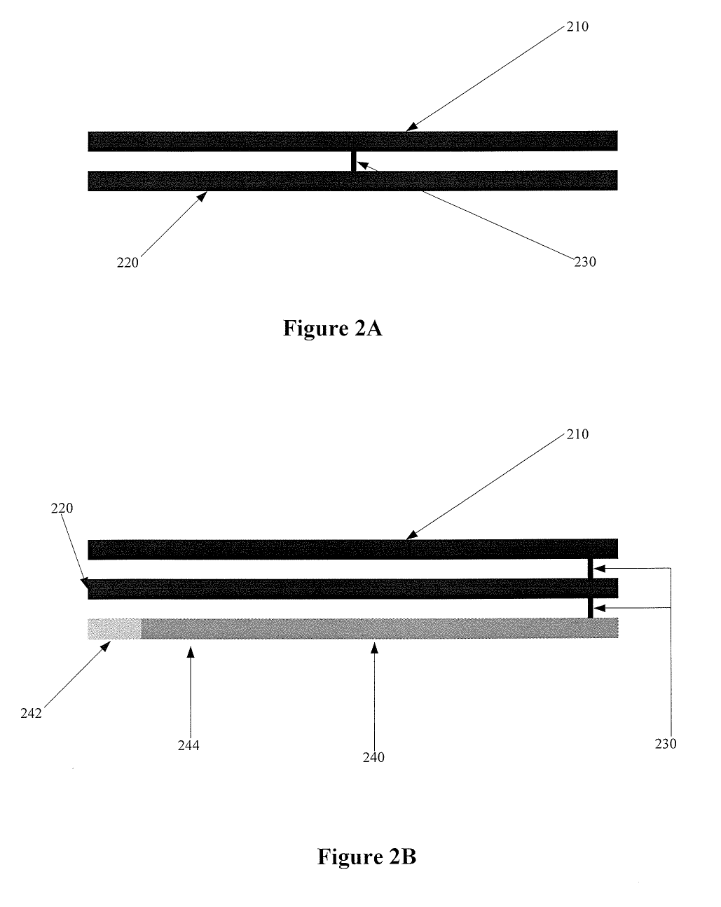

FIG. 2A illustrates one embodiment of a flush line pattern that is printed across the top of each page of a print job. As shown in FIG. 2A, the flush pattern includes line 210 and line 220. According to one embodiment, line 210 is a 4 pel black flush line formed by non black colors implemented (e.g., cyan, magenta and yellow) at print engines 10 and 12, while line 220 is a 4 pel flush line formed by K black. Lines 210 and 220 are separated by a 1 pel tic mark 230. In one embodiment, one tic mark 230 is placed at one inch intervals between line 210 and line 220 in order to define each defective jet location and a corresponding nozzle that responsible for the defective jet. When a defective jet occurs, printer controller 26 detects that the density and/or a color change at the defective jet location at line 210 and/or 220. After printing has been completed flush lines 210 and 220 are removed at post processing component 28 by separator 30.

FIG. 2B illustrates another embodiment of a flush line pattern. In this embodiment a control bar 240 is included that is separated form line 220 by an additional tic mark 230. In a further embodiment, control bar 240 is a 4 pel line that includes a first color (e.g., cyan) component 242 and a second (e.g., magenta) component 244 that provides additional printer information (e.g., color density). The third color (e.g., yellow typically used in a CMYK color printer) is not included. In such an embodiment, cyan component 242 and magenta component 244 are generated by setting each respective component to its maximum density.

In a further embodiment, control bar 240 is a 4 pel line that includes a first color component 242, a second color component 244, and a third color (e.g. yellow) component (not shown) are generated by setting each respective component value to its maximum density. The 4 pel line pattern for each embodiment is repeated numerous times for the line to be full scan width. In other embodiments, a control bar may have more than four color components in printers that implement more than four color components.

After the color bars are read, printer controller 26 measures the color bar densities of control bar 240. For the black component, printer controller 26 measures the density of line 220. Defective jet detection is performed using color bar 210 and color bar 220. In one embodiment, tone curves may be used to maintain the densities if an initial set point is approximately 95% instead of 100% (to provide adjustment range as the print engine drifts). By using density set (reference) points and measured values, various tone curves may be scaled to maintain (or control) the printer densities. In other embodiments, the tic marks 230 separating control bar 240 and line 220 may be changed to another color (e.g., green) to improve the probability at least one tic mark 230 is recognized.

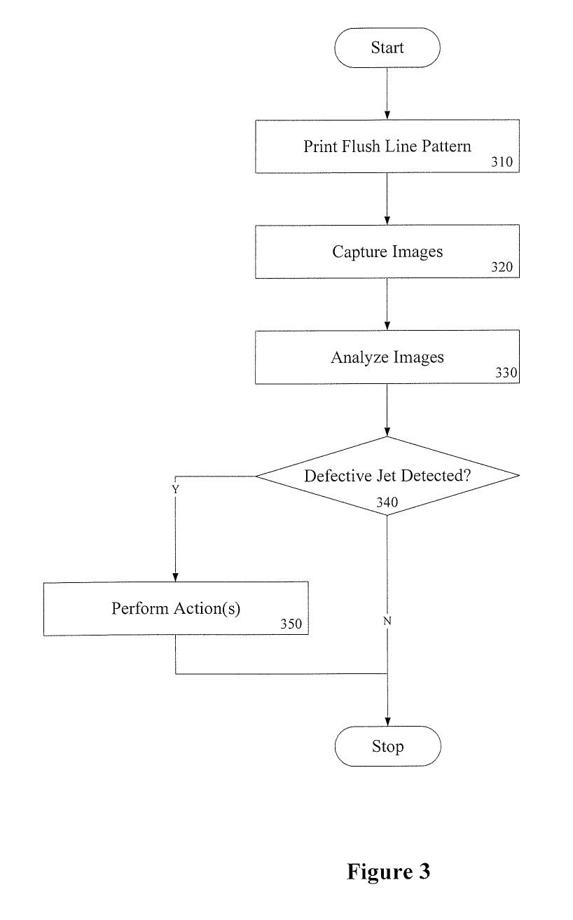

FIG. 3 is a flow diagram for one embodiment of performing defective jet detection. At processing block 310, the flush line pattern is printed. At processing block 320, an image of the flush line pattern is captured by reader 18. At processing block 330, the flush line pattern image is analyzed at printer controller 26 in order to detect the presence of a defective jet.

According to one embodiment, printer controller 26 analyzes the image by measuring color values of lines 210, 220 and/or color bar 240 of the captured flush line pattern. For example, the color values may be measured to identify tints and their transition locations/indices from the image. Once the printed image data is captured and the color values of the image data are measured, print irregularities associated with the flush line pattern are determined.

In one embodiment, the print irregularities are determined by estimating original optical density values for the color values in the flush line pattern and comparing those values to the measured color values to determine differences in order to detect a density and color change of the flush line pattern. A more detailed discussion of analyzing a captured image can be found in patent application Ser. No. 12/868,311 entitled, Printer Calibration for Printers with Fixed Print Array Structures, herein incorporated by reference.

At processing block 340, a determination is made as to whether a defective jet has been detected as a result of the analysis. If a defective jet has been detected one or more actions are performed, processing block 350. In one embodiment, a simple action of recording the analysis is performed. In another embodiment, printer 8 attempts to correct the detected error. In yet another embodiment, the current print job print job is stopped for operator intervention.

The above-described mechanism performs important printer functions such as defective jet detection while using approximately the same ink volume and paper space required for line flushing. The mechanism further, enhances printer data integrity by checking color bar colors.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A printing system comprising:
one or more print engines each having a plurality of ink jet nozzles to print a flush line pattern on a medium;
a reader to capture an image of the flush line pattern; and
a controller to analyze the image of the flush line pattern to extract print quality information.

2. The printing system of claim 1 wherein the flush line pattern comprises:
a first line formed by non black ink colors implemented at the print engines; and
a second line by black ink

3. The printing system of claim 1 wherein the flush line pattern further comprises a tic mark separating the first line and the second line to define corresponding ink jet nozzle locations.

4. The printing system of claim 3 wherein the controller analyzes the image of the flush line pattern by detecting a density and a color change at each component of the flush line pattern corresponding to a ink jet nozzle location.

5. The printing system of claim 4 wherein the controller provides an indication of a defective jet condition at an ink jet nozzle location upon detecting a density or a color change at a component of the flush line pattern corresponding to the ink jet nozzle location.

6. The printing system of claim 3 wherein the flush line pattern further comprises a control bar having two or more color components.

7. The printing system of claim 6 wherein the controller analyzes the image of the control bar by measuring the color density information of each color component.

8. The printing system of claim 6 wherein the flush line pattern further comprises a second tic mark separating the color bar and the second line.

9. The printing system of claim 1 further comprising a post processing device to remove the flush line pattern.

10. A method comprising:
printing a flush line pattern on a medium;
capturing an image of the flush line pattern; and
analyzing the image of the flush line pattern to extract print quality information.

11. The method of claim 10 further comprising:
determining whether a defective jet condition has been detected; and
performing an action if a defective jet condition has been detected.

12. The method of claim 11 wherein performing an action comprises at least one of recording an analysis performed, correcting an error responsible for the defective jet condition and halting a corresponding print job.

13. The method of claim 10 wherein the flush line pattern comprises:
a first line formed by non black ink colors implemented at the print engines; and
a second line by black ink

14. The method of claim 13 wherein analyzing the image of the flush line pattern comprises measuring color values of the first line and the second line in order to detect a density and a color change.

15. The method of claim 13 wherein the flush line pattern further comprises a control bar having two or more color components.

16. The method of claim 15 wherein analyzing the image of the flush line pattern comprises measuring the color density information of the two or more color components of the color bar.

17. The method of claim 10 further comprising removing the flush line pattern from the medium.

18. A method comprising analyzing an image of a flush line pattern applied to a print medium to extract print quality information for an ink jet print head.

19. The method of claim 18 wherein analyzing the image of the flush line pattern comprises measuring color values of the flush line pattern in order to detect a density and a color change.

20. The method of claim 19 wherein analyzing the image of the flush line pattern further comprises measuring color density information of the flush line pattern.

21. The method of claim 20 wherein the measured color density information of the flush line pattern is used to manually or automatically adjust the print engine for constant color density output.
